(19) United States
(12) Patent Application Publication
(10) Pub. No.: US 2026/0133682 A1
(43) Pub. Date: May 14, 2026

(54) DISPLAY METHOD AND ELECTRONIC DEVICE

(71) Applicant: Lenovo (Beijing) Limited, Beijing (CN)

(72) Inventors: Renyun LIN, Beijing (CN); Xuxu WANG, Beijing (CN); Mingping ZHANG, Beijing (CN)

(21) Appl. No.: 19/311,510

(22) Filed: Aug. 27, 2025

(30) Foreign Application Priority Data
Aug. 29, 2024 (CN) 202411203720.8

(51) Int. Cl. G06F 3/04845; G06F 16/25; G06F 40/166

(52) U.S. Cl. CPC G06F 3/04845; G06F 16/258; G06F 40/166

(57) ABSTRACT

A display method includes: obtaining a first target object, including an image and/or a video; displaying the first target object; obtaining a target input; and in response to the target input, displaying a second target object. The second target object is a target object generated by a target model for the first target object; and the second target object is associated with the first target object.

### CROSS-REFERENCE TO RELATED APPLICATION(S)

This application claims priority to Chinese Patent Application No. 2024112037208 filed on Aug. 29, 2024, which is incorporated herein by reference in its entirety.

### FIELD OF THE TECHNOLOGY

The present disclosure relates to a field of electronic device display technology, and in particular to a display method and an electronic device.

### BACKGROUND

When photos and/or videos in an album are being browsed using an electronic device, multiple photo thumbnails are displayed directly on the screen. Users may tap the desired photo or video to enlarge it, resulting in a relatively monotonous display.

A long-press display method may be available to allow for a dynamic image. However, this method may require a particular shooting mode, in that the video may need to be recorded in a particular shooting mode to achieve the dynamic image display effect. When the particular shooting mode is not used or the electronic device does not support the mode, the dynamic image display effect may not be achieved by long-pressing. As such the display of photos or videos in an album remains monotonous.

### SUMMARY

In one aspect, the present disclosure provides a display method. The method includes: obtaining a first target object, including an image and/or a video; displaying the first target object; obtaining a target input; and in response to the target input, displaying a second target object, where the second target object is a target object generated by a target model for the first target object; and the second target object is associated with the first target object.

In another aspect, the present disclosure provides an electronic device. The device includes: a display screen; and a processor connected to the display screen, where the processor is configured to perform: obtaining a first target object, including an image and/or a video; displaying the first target object; obtaining a target input; and in response to the target input, displaying a second target object, wherein the second target object is a target object generated by a target model for the first target object; and the second target object is associated with the first target object.

In yet another aspect, the present disclosure provides a display method. The method includes: obtaining a first target object, including an image and/or a video; displaying the first target object; obtaining a target input; and in response to the target input, displaying a second target object, wherein the second target object is generated by a target model according to the first target object.

In yet another aspect, the present disclosure provides an electronic device. The device includes: a memory storing computer program instructions; and a processor coupled to the memory and configured to execute the computer program instructions and perform: obtaining a first target object, including an image and/or a video; displaying the first target object; obtaining a target input; and in response to the target input, displaying a second target object, wherein the second target object is generated by a target model according to the first target object.

In yet another aspect, the present disclosure provides a non-transitory computer-readable storage medium storing computer program instructions executable by at least one processor to perform: obtaining a first target object, including an image and/or a video; displaying the first target object; obtaining a target input; and in response to the target input, displaying a second target object, wherein the second target object is generated by a target model according to the first target object.

### BRIEF DESCRIPTION OF THE DRAWINGS

To illustrate the technical solutions of the present disclosure, the following briefly introduces the figures in relation to certain embodiments. The figures described below represent certain embodiments. Persons skilled in the technical field may derive other figures based on these figures without inventive effort.

FIG. 1 shows a flowchart of a display method provided in certain embodiments of the present disclosure;

FIG. 2 shows a schematic diagram of displaying a photo album within a display area of a display screen provided in certain embodiments of the present disclosure;

FIG. 3 shows a schematic diagram of displaying eight first target objects and one second target object within a display area of a display screen provided in certain embodiments of the present disclosure;

FIG. 4 shows a schematic diagram of displaying a second target object within each sub-display area of a display screen provided in certain embodiments of the present disclosure;

FIG. 5 shows a schematic diagram of a first target object provided in certain embodiments of the present disclosure;

FIG. 6 shows a schematic diagram of a second target object provided in certain embodiments of the present disclosure;

FIG. 7 shows a schematic diagram of a transition object provided in certain embodiments of the present disclosure;

FIG. 8 shows a flowchart of a method for generating a second target object in a display method provided in certain embodiments of the present disclosure;

FIG. 9 shows a flowchart of a display method provided in certain embodiments of the present disclosure;

FIG. 10 shows a flowchart of a display method provided in certain embodiments of the present disclosure;

FIG. 11 shows a schematic diagram of a structure of an electronic device provided in certain embodiments of the present disclosure.

### DETAILED DESCRIPTION

Various aspects and features of the present disclosure are described herein with reference to the accompanying drawings.

Various modifications may be made to the embodiments of the present disclosure. The description should not be construed as limiting, but merely as illustrative of embodiments. Other modifications within the scope and spirit of the present disclosure occur to those skilled in the technical field.

The accompanying drawings, which are incorporated in and constitute a part of the present disclosure, illustrate embodiments of the present disclosure and, together with the description of the present disclosure given herein, serve to explain the principles of the present disclosure.

These and other features of the present disclosure become apparent from the following description of embodiments, which are given as non-limiting examples with reference to the accompanying drawings.

Those skilled in the technical field may realize many other equivalent forms of certain embodiments of the present disclosure that have the features recited in the claims and the equivalents are within the scope of protection of the present disclosure.

The foregoing and other aspects, features, and advantages of the present disclosure become more apparent from the following detailed description when taken in conjunction with the accompanying drawings.

Certain embodiments of the present disclosure are described hereinafter with reference to the accompanying drawings; the embodiments described are merely examples of the present disclosure and may be implemented in various ways. Well-known and/or repetitive functions and structures are not described in detail to avoid obscuring the present disclosure with unnecessary or redundant detail. Therefore, the structural and functional details disclosed herein are not necessarily limiting but rather serve as a basis and representative basis for the claims, teaching those skilled in the technical field to variously employ the present disclosure.

When applicable, phrases “in one embodiment,” “in another embodiment,” “in yet another embodiment,” or “in other embodiments” or “in certain embodiments” refer to one or more of the same or different embodiments of the present disclosure.

To facilitate understanding of the present disclosure, a display method provided herein is described. The display method according to certain embodiments of the present disclosure is applied in the scenario of browsing the photo album using the display screen of the electronic device. It is applied to the processor of the electronic device. Through this display method, the problem of monotonous display of pictures or videos in the photo album may be solved. Moreover, without the need for a particular shooting mode, the second target object corresponding to the first target object may be obtained through the target model, and the operation is simple.

In certain embodiments, FIG. 1 illustrates a flowchart of a display method. The method includes S101-S104.
S101: Obtain a first target object. The first target object includes a picture or a video.

In an implementation, a photo album includes multiple objects, each of which may be a picture or a video. The objects in the photo album, for example, the pictures or videos, may be collected by a capture device of an electronic device, transmitted to the electronic device from another device, or downloaded from the Internet.

In certain embodiments, the first target object is obtained from the photo album. The first target object includes a picture or a video.

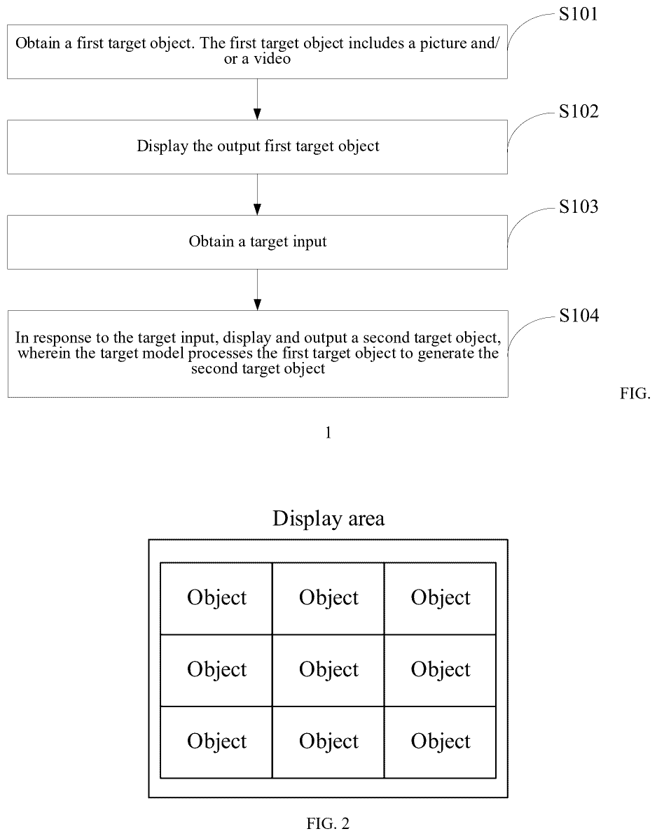

In certain embodiments, the first target object is determined based on a user's touch action, gesture, or voice. For example, FIG. 2 illustrates a schematic diagram of displaying an output photo album within a display area of a display screen. In FIG. 2, each object in the photo album is displayed as a thumbnail. That is, a preset number of objects may be displayed simultaneously within the display area of the display screen. When a user touches one of the objects, the touched object is determined as the first target object.
S102: Display the output first target object.

After obtaining the first target object, the display screen of the electronic device is controlled to display the first target object. In certain embodiments, before displaying the first target object, a thumbnail of the first target object is adjusted. A first size of a display area of the display screen is determined. A second size of the first target object is adjusted according to the first size until the second size is the same as the first size. The display area is controlled to display the first target object.

Adjusting the second size of the first target object includes any one or more of the following: enlarging, restoring, and changing pixel values.
S103: Obtain a target input.

In an implementation, a user may perform a preset operation on the first target object, causing the processor to obtain an input corresponding to the preset operation. Different preset operations, for example, different inputs, correspond to different display effects. In certain embodiments, the preset operations may include multiple types, such as tapping, long pressing, and moving.

In an implementation, the target input is obtained based on the target operation performed by the user. The target operation may be set to be a long press on the first target object for greater than or equal to 3 seconds, or to move the first target object to a target position and hold it for greater than or equal to 5 seconds.
S104: In response to the target input, display a second target object, where the second target object is a target object generated by the target model for the first target object; the second target object is associated with the first target object when generated.

In certain embodiments, the second target object may be generated for the first target object using the target model in response to the target input after receiving the target input. In certain embodiments, the second target object may be generated for the first target object using the target model before receiving the target input. For example, when the CPU usage of the electronic device is low or there is a large amount of unused memory space in the electronic device, the second target object may be generated for the first target object using the target model.

In certain embodiments, because storing and running the target model in the electronic device requires processing resources and memory space of the CPU of the electronic device, the target model may be stored in the cloud. That is, when generating the second target object for the first target object, the first target object is transmitted to the cloud, so that the target model stored in the cloud processes the first target object to generate the first target object, and then returns the second target object to the electronic device. Therefore, compared to storing the target model on the electronic device, storing the target model in the cloud may reduce the processing resources and memory space occupied by the target model on the electronic device's central processing unit. In certain embodiments, compared to storing the target model in the cloud, storing the target model on the electronic device may ensure that the speed of displaying the second target object is not affected by network communication speed.

The target model in certain embodiments of the present disclosure may be stored on the electronic device or in a cloud that may communicate with the electronic device.

After obtaining the target input, the second target object is displayed in response to the target input. The second target object may be one or more. When displaying the second target object, one of the second target objects may be displayed according to the display conditions, or all of the second target objects may be displayed sequentially.

When the second target object is generated, it is associated with the first target object. For example, the second target object and the first target object have the same main structure. After the second target object is generated, it may be stored in a new group in the album to distinguish between objects generated by the target model and objects not generated by the target model. The second target object may also be stored in the same group as the first target object to clearly identify the associated second target object and the first target object. In certain embodiments, each object in the album may be used as the first target object.

For example, each object in the album may be determined as the first target object without any determination conditions (such as the user's touch action, gesture, and voice, or the like); since generating a target object for the first target object requires occupying the processing resources and memory space of the central processing unit of the electronic device, based on this, without any determination conditions, some objects in the album may be determined as the first target object according to the processing resources and memory space of the central processing unit, for example, the object captured by the image acquisition device of the electronic device is determined as the first target object, or the like.

When displaying thumbnails of multiple objects within the display area of a display screen, a target input may also be obtained to display a second target object in response to the target input, or the second target object may be directly displayed and output.

Continuing with the example shown in FIG. 2, in this example, thumbnails of nine objects are displayed within the display area. In a scenario where all nine objects are first target objects, the user may perform a preset operation to instruct the display of a second target object corresponding to a first target object. For example, the user double-clicks one of the first target objects. After the thumbnail is displayed and output, the second target object corresponding to the first target object is displayed in response to the double-click, while the other first target objects remain displayed. In an implementation, the first target objects and the second target objects are displayed alternately. Therefore, at a certain moment after responding to a double-click on a first target object, eight first target objects and one second target object are simultaneously displayed within the display area. This is illustrated in FIG. 3, which shows that the eight first target objects and one second target object are also thumbnails.

In certain embodiments, when four of the nine objects displayed in the display area are first target objects, the first target objects may be displayed separately from non-first target objects. For example, the first target objects may be visually labeled, while the non-first target objects may be unlabeled. This allows the user to perform actions, such as double-clicking, on the first target object to indicate the display of the second target object, avoiding the poor user experience caused by performing actions on non-first target objects but failing to display the second target object.

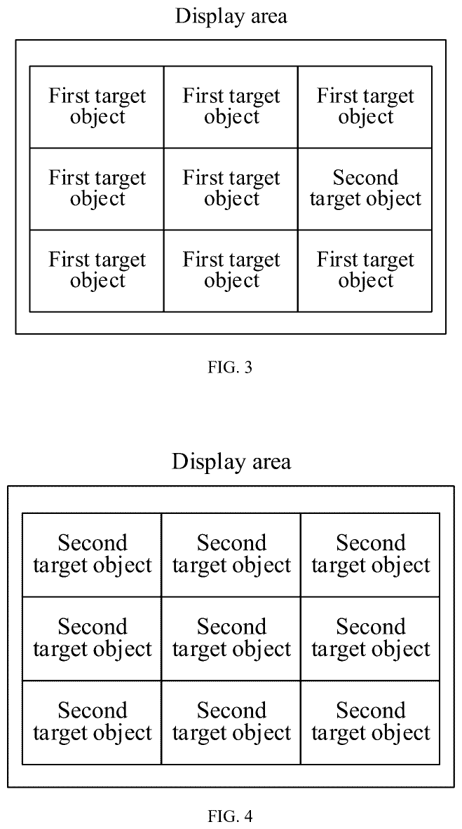

In certain embodiments, in a scenario where nine object thumbnails are displayed simultaneously in the display area, and all nine objects are first target objects, the second target object corresponding to each first target object may be displayed directly without any further action. The first and second target objects are alternately displayed in the sub-display area where each first target object's thumbnail resides. During this process, at some point, all sub-display areas within the display area display the second target objects. FIG. 4 shows a schematic diagram of each sub-display area displaying the second target object. Each second target object is also a thumbnail. This approach is also applicable to scenarios where some of the objects displayed in the display area are first target objects. This approach enhances the richness of album displays.

In certain embodiments, after receiving a target input for a first target object, a second target object generated by the target model for the first target object is displayed in response to the target input. Without requiring a particular shooting mode, the target model may be used to obtain the second target object corresponding to the first target object and display the second target object based on the target input. This solves the problem of monotonous display of images or videos in an album and provides simple operation.

In certain embodiments, when displaying a second target object in response to a target input, in response to the input operation, the display size of the first target object in the target display area is determined, and the size of the second target object is adjusted according to the display size of the first target object. The size of the second target object is adjusted to the display size of the first target object. The target display area of the first target object is refreshed based on the second target object so that the target display area displays and outputs the second target object.

In certain embodiments, the adjusted size of the second target object is the same as the display size of the first target object. The main subject of the second target object relative to the outline of the target display area is consistent with the main subject of the first target object relative to the outline of the target display area. For example, the main bodies of the first and second target objects include a vehicle. When the target display area displays and outputs the first target object, the vehicle has a first relative positional relationship with the outline of the target display area. When the target display area displays and outputs the second target object, the vehicle has a second relative positional relationship with the outline of the target display area. The first relative positional relationship and the second relative positional relationship are identical or within a certain range of errors.

When displaying the second target object in response to a target input, the target display area of the first target object on the display screen may also be determined, the size of the target display area obtained, and the size of the second target object adjusted according to the size of the target display area. This is not limited in certain embodiments of the present disclosure.

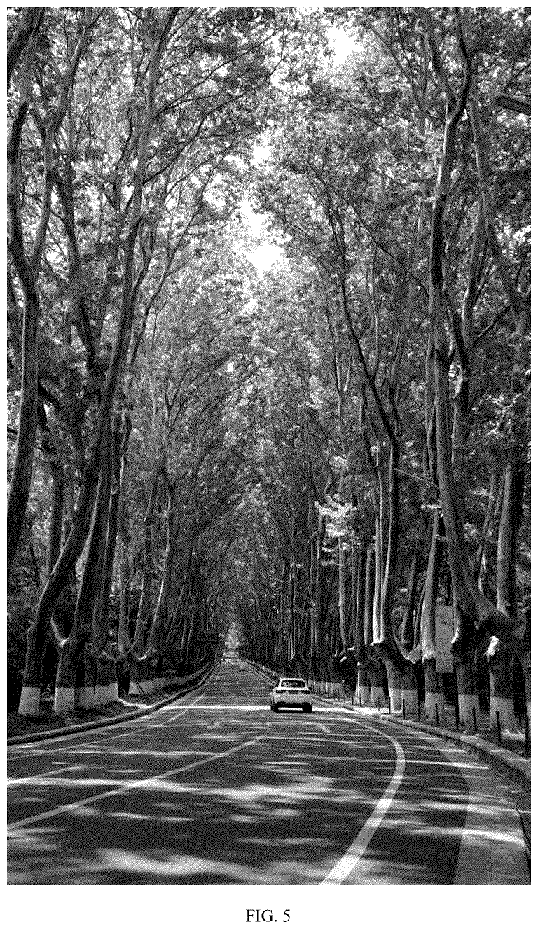

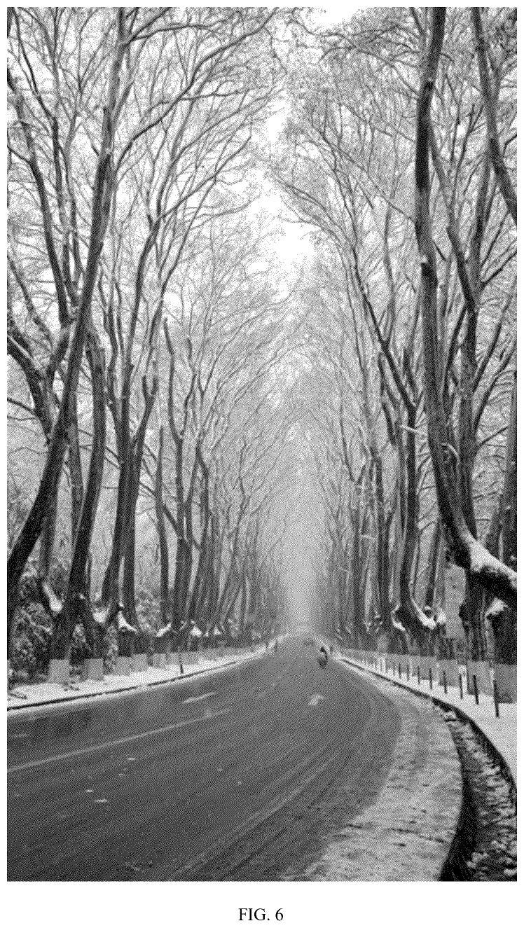

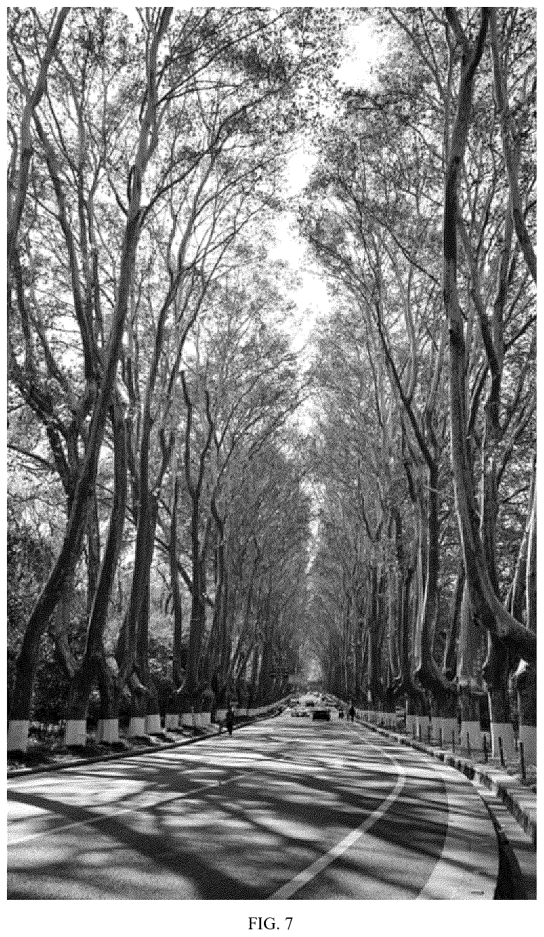

In an implementation, the second target object and the first target object have the same main subject, but the display effects of the second target object and the first target object are different. For example, FIG. 5 shows a schematic diagram of the first target object, and FIG. 6 shows a schematic diagram of the second target object. The main subjects of both the first and second target objects are an asphalt road and trees on either side of the road. The display effect of the first target object is an asphalt road and trees on either side of the road in summer, while the display effect of the second target object is an asphalt road and trees on either side of the road in winter.

In certain embodiments, while the target model generates the second target object for the first target object, it may also generate multiple transition objects. These multiple transition objects are target objects generated by the target model for the first target object. These multiple transition objects are also associated with the first target object when generated, and the transition objects and the second target objects may be stored in the same group. Furthermore, the multiple transition objects are located between the first target object and the second target object. For example, the first target object, the transition object, and the second target object each have a corresponding time tag. The time tag corresponding to the transition object represents a transition time point. The time tag corresponding to the first target object represents the first time point, and the time tag corresponding to the second target object represents the second time point. The transition time point is between the first time point and the second time point.

In certain embodiments, when displaying the second target object in response to a target input, the target display area of the first target object is periodically or continuously or sequentially refreshed based on the multiple transition objects and the second target objects in response to the input operation to display the second target object. The multiple transition objects and the second target objects are periodically or continuously and sequentially displayed in the target display area.

In certain embodiments, FIG. 7 shows a schematic diagram of a transition object, which displays an asphalt road and trees on both sides of the road in autumn. When the second target object is displayed in response to the target input, the target display area of the first target object is periodically or continuously or sequentially refreshed using FIG. 7 and FIG. 6.

In certain embodiments, the second target object has the same main subject as the first target object. An outline of the main subject of the second target object relative to the target display area, is in alignment with an outline of the main subject of the first target object relative to the target display area, and an outline of the main subject of the transition object relative to the target display area, is in alignment with an outline of the main subject of the first target object relative to the target display area. The second target object, the first target object, and the transition object each have different display effects.

The second target object may be displayed in response to a target input. The target display area of the first target object may be refreshed with the second target object to display the second target object. Multiple transition objects and second target objects may also be used to refresh the target display area of the first target object to display the second target object. This design enhances the richness of the object display in the album, thereby improving the user experience. No particular requirements may be needed for the electronic device's functionality or the mode for obtaining objects in the album, resulting in a low implementation cost.

Every object in the album may serve as a first target object. Without any determination conditions (such as user touch actions, gestures, and voice, or the like), each object in the album is determined as the first target object. A second target object or multiple transition objects and second target objects may be generated in advance for the first target object, and the generated second target object or multiple transition objects and second target objects are associated with the first target object and stored. When the target input is received, the second target object or multiple transition objects and second target objects may be displayed and output, and the display output efficiency is high.

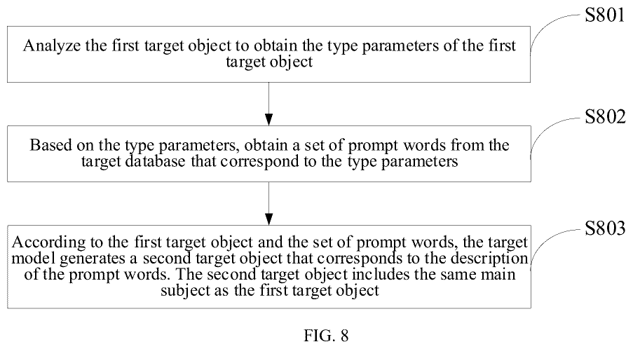

In certain embodiments, before displaying the second target object, the target model is used to generate the second target object. As an example, FIG. 8 shows a flowchart of a method for generating the second target object, including steps S801-S803.
S801: Analyze the first target object to obtain the type parameters of the first target object.
S802: Based on the type parameters, obtain a set of prompt words from the target database that corresponds to the type parameters.
S803: According to the first target object and the set of prompt words, the target model generates a second target object that corresponds to the description of the prompt words. The second target object includes the same main subject as the first target object.

When generating the second target object for the first target object, the first target object is first analyzed to obtain the type parameters of the first target object. In certain embodiments, a pre-trained recognition model is used to identify and analyze the first target object to obtain the type parameters of the first target object. The recognition model may be a TensorFlow Lite model, a VGG model, an Inception series model, a ResNet series model, or the like.

Among them, the type parameters of the first target object may characterize the type of the first target object. For example, the type parameters of the first target object include the element name, the area ratio of each element in the first target object, or the like. The types of the first target object include scenery, buildings, sky, and people, or the like.

After obtaining the type parameters of the first target object, a set of prompt words that correspond to the type parameters are obtained from the target database based on the type parameters. The target database pre-stores a mapping between type parameters and prompt words, and one type parameter may correspond to multiple prompt words, meaning one type parameter may correspond to either one prompt word or a set of prompt words.

After obtaining the set of prompt words that correspond to the type parameters of the first target object, a target model is used to generate a second target object that corresponds to the description of the prompt words based on the first target object and the set of prompt words. For example, when the type parameters of the first target object indicate that the first target object belongs to the “landscape” category, and the corresponding prompt words obtained from the target database are “maintaining the photographic main subject structure” and “generating images of all four seasons,” the target model is used to generate a second target object based on the main subject structure of the first target object and elements such as the four seasons. The generated second target object includes the same main subject as the first target object and corresponds to the description of any of the four seasons.

In one implementation, in order to meet the user's display needs, after displaying the second target object, the user's feedback information on the display effect of the second target object is obtained. Based on the feedback information, the target database is updated so that the generated second target object may better meet the user's display needs.

In certain embodiments, the target database has dynamically changing properties. Some prompt words in the target database contain dynamically changing properties, such as prompt words related to location, weather, and other content. These dynamically changing prompt words are provided with real-time determination. Therefore, after obtaining a set of prompt words that correspond to the type parameters and before generating a second target object that corresponds to the description of the prompt word, the characters of the target prompt word in the target database are updated. This target prompt word is a prompt word with dynamically changing properties.

In certain embodiments, when updating the characters of the target prompt word, target characters are used to update the characters of the target prompt word in the target database. Therefore, before updating the characters of the target prompt word in the target database, the target characters are obtained by one or more of: obtaining sensing parameters from a target sensor and converting the sensing parameters into target characters, or obtaining target parameters from a network communication device and converting the target parameters into target characters.

In certain embodiments, the method for obtaining the target characters is determined based on the target prompt word. For example, when the target prompt word involves location, a sensing parameter is obtained through at least one of a positioning sensor, such as a gyroscope, a GPS positioning sensor, or an inertial navigation sensor. The sensing parameter represents the current location of the electronic device. The sensing parameter is converted into a target character, and the target character is used to update the target prompt word character in the target database. When the target prompt word involves weather, a target parameter is obtained through at least one of a network communication device, such as an antenna, a network card, or a cable. The target parameter represents the current weather conditions. The target parameter is converted into a target character, and the target character is used to update the target prompt word character in the target database.

This helps ensure the accuracy of the prompt words corresponding to the type parameters, and the second target object generated based on the prompt words may better meet the user's display requirements.

The update condition for the target prompt words may be a change in the sensing parameters obtained by the target sensor, a change in the target parameters obtained by the network communication device, or a change in the target input.

In certain embodiments, a first model is configured to obtain prompt words corresponding to the type parameters of the first target object. Before displaying the second target object, the first model is used to process the first target object to obtain a set of prompt words. The prompt words are used by the target model to generate a second target object based on the first target object that matches the description of the prompt words. The first model may perform recognition, extraction, matching, and generation. For example, it may recognize the first target object to determine its type, then match corresponding prompt words based on the type of the first target object to obtain a set of prompt words. The first model may also be pre-configured with a generation rule for generating a set of prompt words based on elements. The first model may extract elements from the first target object and then, according to the generation rule, generate a set of prompt words based on all elements. The parameters and processing steps in the first model may be set, as long as the prompt word corresponding to the first target object may be obtained. The embodiments of the present disclosure do not make limitations on this.

In certain embodiments of the present disclosure, when processing a first target object based on a first model to obtain a set of prompt words, the first target object is converted into vector features, and the vector features are then computed with a vector feature library using the first model to generate a set of prompt words. The vector feature library represents the relationship between the first target object and the prompt words.

After obtaining a set of prompt words corresponding to the first target object, the set of prompt words is transmitted to the target model, so that the target model generates a second target object that corresponds to the description of the prompt words based on the first target object and the set of prompt words. The steps for the target model to generate a second target object that corresponds to the description of the prompt words based on the first target object and the set of prompt words are the same as described above and are not further described here.

In certain embodiments, the set of prompt words obtained by processing the first target object based on the first model also includes target prompt words with dynamically changing properties. When generating a set of prompt words using the first model, sensing parameters are obtained from a target sensor and transmitted to the target model, so that the target model converts the sensing parameters into target characters and generates a set of prompt words based on the target characters, the vector features, and the vector feature library. Alternatively, when generating a set of prompt words using the first model, target parameters are obtained via a network communication device and transmitted to the target model. The target model then converts the target parameters into target characters and generates a set of prompt words based on the target characters, vector features, and the vector feature library. The target characters serve as the characters of the target prompt words.

The target sensor, sensing parameters, network communication device, and target parameters are described above and are not further elaborated here.

Compared to updating the target prompt word when the sensing parameters obtained by the target sensor or the target parameters obtained by the network communication device change, updating the target prompt word in real time based on the first model after receiving the target input may avoid wasting resources caused by prematurely updating the target prompt word but not using the updated target prompt word.

In an implementation, when the target model generates multiple transition objects with the second target object for the first target object, the target model generates, based on the first target object and a set of prompt words, multiple transition objects that correspond to the description of the prompt words and a second target object that corresponds to the description of the prompt words. The set of prompt words includes a ranking parameter configured for the target model, which indicates the number of transition objects to be generated.

For example, when the ranking parameter of the target model is 11 and the first target object is a spring landscape, the target model generates, based on the first target object and the set of prompt words, 10 transition objects that correspond to the description of the prompt words and a second target object that corresponds to the description of the prompt words. In certain embodiments, the first target object, the 10 transition objects, and the second target object correspond to landscapes of different months. In response to an input operation, the first target object, the transition object, and the second target object may refresh the target display area of the first target object in the order of their respective corresponding time points, thereby realizing the transition presentation of different months and seasons.

In certain embodiments, when the prompt word includes time and related vocabulary, a corresponding timeline virtual control key may be generated with the generation of multiple transition objects and second target objects. This timeline virtual control key is used to respond to user touch operations, such as sliding, to control the transition object or second target object to refresh the target display area, thereby controlling the display progress of the transition object and second target object, providing greater flexibility.

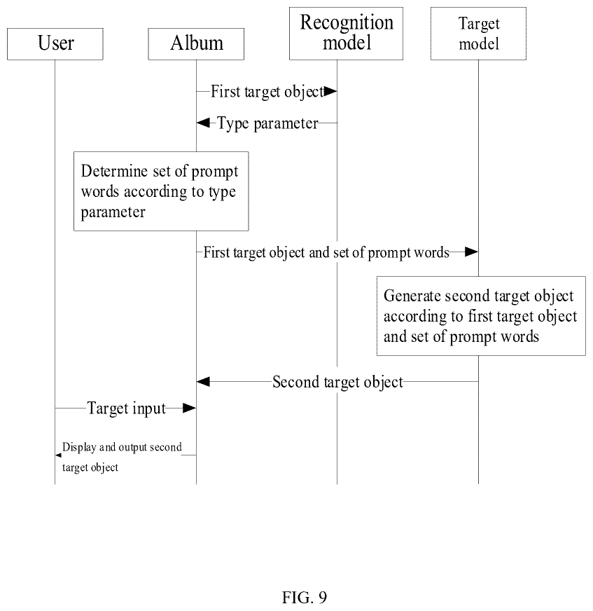

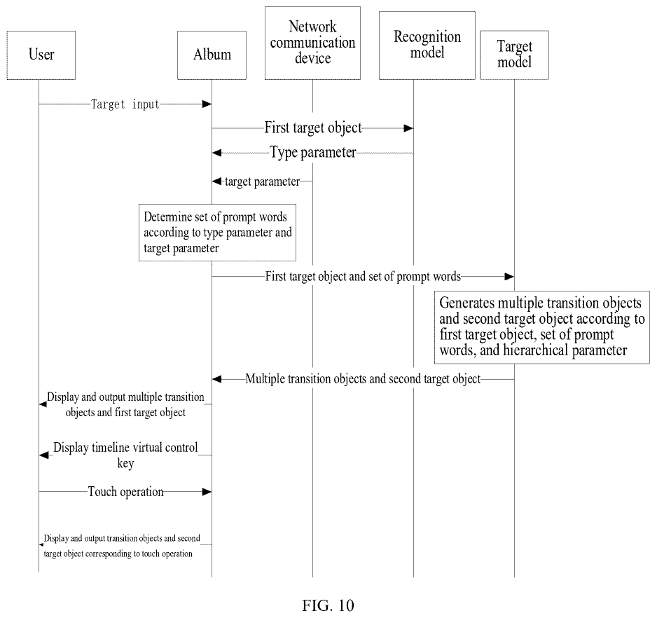

In certain embodiments, FIG. 9 shows a flowchart of a display method. In this scenario, each object in an album is identified as a first target object, and a second target object is pre-generated for the first target object. The first target object is transmitted to a recognition model, which identifies and analyzes the first target object to obtain a type parameter that characterizes the type of the first target object. After obtaining the type parameter of the first target object, a set of prompt words corresponding to the type parameter is obtained from a target database based on the type parameter. The first target object and the set of prompt words corresponding to its type parameter are then transmitted to the target model. Based on the first target object and the set of prompt words, the target model generates a second target object that corresponds to the description of the prompt words. After the target model generates the second target object, the second target object is transferred to the album and stored in the same group as the first target object. When the user generates a target input based on an interactive device such as a touch screen, the second target object is displayed in response to the target input.

In certain embodiments, FIG. 10 shows a flowchart of a display method. Referring to FIG. 10, a transition object and a second target object are generated in real time based on a user's target input. When a user generates a target input using an interactive device such as a touch screen, in response to the target input, a first target object is transmitted to a recognition model. The recognition model identifies and analyzes the first target object, obtaining a type parameter that characterizes the type of the first target object. The current target parameter is obtained via a network communication device. A set of prompt words is determined based on the type parameter and the target parameter. The first target object and its matching set of prompt words are then transmitted to the target model. The target model is configured with a hierarchical parameter. The target model generates multiple transition objects and a second target object based on the first target object, the set of prompt words, and the hierarchical parameter. The multiple transition objects and the second target object are then transmitted to an album, stored in the same group as the first target object, and displayed. The multiple transition objects and the second target object are used to refresh the target display area of the first target object, thereby displaying the multiple transition objects and the second target object to the user. A corresponding timeline virtual control key is provided. This timeline virtual control key is displayed, and a user performs a touch operation on the timeline virtual control key. Based on this control operation, a transition object or a second target object corresponding to the control operation is displayed. The target display area is refreshed using the transition object or the second target object corresponding to the control operation.

In certain embodiments, after displaying the second target object, a satisfaction survey questionnaire for the second target object may be generated and displayed. Users may then provide feedback via the satisfaction survey questionnaire. After obtaining user feedback, the target model is updated or adjusted based on this satisfaction information, so that the second target object generated by the target model improves user satisfaction.

A second aspect of the present disclosure provides an electronic device corresponding to the display method. Since the principles underlying the problem solved by the electronic device are similar to those of the display method described above, the implementation of the electronic device may be referred to in the implementation of the method, and any repetitive details will be omitted.

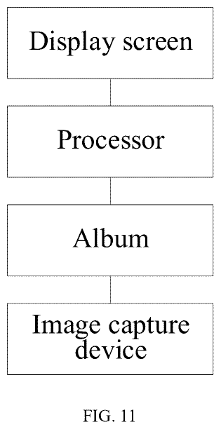

FIG. 11 shows a schematic diagram of an electronic device provided in certain embodiments of the present disclosure. As shown in FIG. 11, the electronic device includes a display screen and a processor connected to each other.

The processor is configured to obtain a first target object, where the first target object includes an image or a video;
control the display screen to display the first target object;
obtain a target input;
and, in response to the target input, control the display screen to display a second target object, where the second target object is generated by the target model for the first target object, and the second target object is associated with the first target object when generated.

Continuing with FIG. 11, the electronic device further includes:
An image capture component for storing captured objects in an album. The objects include pictures and/or videos. The objects in the album may be identified as first target objects.

In certain embodiments, the storage medium may include, but is not limited to, a USB flash drive, read-only memory (ROM), random access memory (RAM), a removable hard drive, a magnetic disk, or an optical disk, among other media capable of storing program code. In certain embodiments, the processor executes the method steps described in the above embodiment based on the program code stored in the storage medium. Relevant examples in the storage medium embodiments may refer to the examples described in the device and method embodiments, and description is not repeated here for brevity. Those skilled in the technical field understand that the modules or steps of the present disclosure described above may be implemented using a general-purpose computing device, they may be concentrated on a single computing device, or distributed on a network composed of multiple computing devices. Alternatively, they may be implemented using program code executable by the computing device, so that they may be stored in a storage device and executed by the computing device. Steps shown or described may be performed in a different order than herein, or they may be made into separate integrated circuit modules, or multiple modules or steps may be made into a single integrated circuit module for implementation. Thus, the present disclosure is not limited to any combination of hardware and software.

Furthermore, while exemplary embodiments have been described herein, their scope includes any and all embodiments based on the present disclosure with equivalent elements, modifications, omissions, combinations (for example, overlapping embodiments), adaptations, or variations. The elements of the claims are to be interpreted broadly based on the language employed in the claims and are not limited to the examples described in the present disclosure or during the prosecution of the present disclosure, where examples are to be construed as non-exclusive. The description and examples are examples only, with the scope and spirit being indicated by the following claims and their full scope of equivalents.

The description is illustrative and not restrictive. For example, the above examples (or one or more aspects thereof) may be combined with each other. For example, a person of ordinary skill in the technical field may utilize other embodiments upon reading the above description. Additionally, in the foregoing detailed description, various features may be grouped together to simplify the disclosure. This should not be interpreted as an intention that an unclaimed disclosed feature is essential to any claim. The present disclosure may include less than all features of a particular disclosed embodiment. Thus, the following claims are hereby incorporated into the detailed description as examples or embodiments, with each claim standing on its own as a separate embodiment, and it is contemplated that these embodiments may be combined with each other in various combinations or permutations. The scope of the present disclosure should be determined with reference to the appended claims, along with the full scope of equivalents to which such claims are entitled.

The above describes in detail several embodiments of the present disclosure, but the present disclosure is not limited to these described embodiments. Those skilled in the technical field may make various variations and modifications to the embodiments based on the concept of the present disclosure, and these variations and modifications should fall within the scope of protection claimed by the present disclosure.

What is claimed is:

1. A display method, comprising:
obtaining a first target object, including an image and/or a video;
displaying the first target object;
obtaining a target input; and
in response to the target input, displaying a second target object, wherein the target model processes the first target object to generate the second target object.

2. The display method of claim 1, wherein displaying the second target object in response to the target input includes:
in response to an input operation, refreshing a target display area of the first target object to display the second target object, wherein the second target object has a same main subject as the first target object, an outline of the second target object's main subject relative to the target display area is consistent with an outline of the first target object's main subject relative to the target display area, and the second target object and the first target object present different display effects.

3. The display method of claim 1, wherein displaying the second target object in response to the target input includes:
in response to an input operation, continuously refreshing a target display area of the first target object based on a plurality of transition objects and the second target object to display the second target object;
the plurality of transition objects are target objects generated by the target model for the first target object, the plurality of transition objects being associated with the first target object, and the plurality of transition objects being located between the first target object and the second target object;
the second target object has a same main subject as the first target object, an outline of the second target object's main subject relative to the target display area is consistent with an outline of the first target object's main subject relative to the target display area, and the second target object and the first target object present different display effects.

4. The display method of claim 1, before displaying the second target object, further comprising:
analyzing the first target object to obtain a type parameter of the first target object;
based on the type parameter, obtaining a set of prompt words corresponding to the type parameter from a target database; and
based on the first target object and the set of prompt words, generating, by the target model, the second target object corresponding to a description of the prompt words, wherein the second target object includes a same main subject as the first target object.

5. The display method of claim 4, further comprising:
updating characters of a target prompt word in the target database, wherein the target prompt word has a dynamically changing property;
wherein updating characters of the target prompt word in the target database includes at least one of:
obtaining sensing parameters via a target sensor, converting the sensing parameters into target characters, and using the target characters to update characters of the target prompt word in the target database; and
obtaining target parameters via a network communication device, converting the target parameters into target characters, and using the target characters to update characters of the target prompt word in the target database.

6. The display method of claim 1, before displaying the second target object, further comprising:
processing the first target object based on a first model to obtain a set of prompt words, wherein the prompt words are used by the target model to generate, based on the first target object, the second target object that corresponds to a description of the prompt words;
based on the first target object and the set of prompt words, the target model generates the second target object that corresponds to the description of the prompt words, wherein the second target object includes a same main subject as the first target object; and
processing the first target object based on the first model to obtain the set of prompt words includes:
converting the first target object into vector features;
computing the vector features with a vector feature library to generate the set of prompt words.

7. The display method of claim 6, wherein the set of prompt words includes a target prompt word, and the target prompt word has a dynamically changing attribute;
the display method further comprises at least one of:
obtaining sensing parameters via a target sensor, converting the sensing parameters into target characters, and using the target characters as the characters of the target prompt word; and
obtaining target parameters via a network communication device, converting the target parameters into target characters, and using the target characters as the characters of the target prompt word.

8. The display method of claim 4, wherein generating the second target object that corresponds to the description of the prompt word includes:
based on the first target object and the set of prompt words, generating by the target model the plurality of transition objects that corresponds to a description of the prompt words and the second target object that corresponds to the description of the prompt words;
the set of prompt words includes hierarchical parameters for configuring the target model.

9. An electronic device, comprising:
a display screen; and
a processor,
wherein the processor is configured to perform:
obtaining a first target object, including an image and/or a video;
displaying the first target object;
obtaining a target input; and
in response to the target input, displaying a second target object, wherein the target model processes the first target object to generate the second target object.

10. The electronic device of claim 9, further comprising:
an image capture component, for storing captured objects in an album, wherein the objects include a picture and/or a video, and the objects in the album are the first target object.

11. A display method, comprising:
obtaining a first target object, including an image and/or a video;
displaying the first target object;
obtaining a target input; and
in response to the target input, displaying a second target object using a transition object, wherein the second target object is generated by a target model according to the first target object.

12. The display method of claim 11, wherein the first target object is displayed in a target display area, and displaying the second target object includes:
removing the first target object from being displayed in the target display area; and
displaying instead the second target object in the target display area.

13. The display method of claim 12, further comprising:
alternating a display of the first target object in the target display area and a display of the second target object in the target display area.

14. The display method of claim 12, wherein the target display area includes a first target display area and a second target display area different from the first target display area, the first target object is displayed in the first target display area and the second target object in displayed in a second target display area.

15. The display method of claim 11, wherein a main subject of the second target object is consistent with a main subject of the first target object.

16. The display method of claim 11, wherein an outline of a main subject of the second target object is consistent with an outline of a main subject of the first target object.

17. The display method of claim 11, wherein a display effect of the second target object differs from a display effect to the first target object.

18. The display method of claim 11, further comprising:
displaying the transition object according to the first target object, the transition object being different from the second target object.

19. The display method of claim 18, wherein the transition object is generated by the target model.
